(19) United States
(12) Patent Application Publication
(10) Pub. No.: US 2022/0316333 A1
(43) Pub. Date: Oct. 6, 2022

(54) GROUND MILLING MACHINE WITH ENERGY SUPPLY SYSTEM, METHOD FOR OPERATING A GROUND MILLING MACHINE, AND METHOD FOR RETROFITTING A GROUND MILLING MACHINE

(71) Applicant: BOMAG GmbH, Boppard (DE)

(72) Inventors: Nils Muders, Boppard (DE); Martin Werner, Boppard (DE)

(21) Appl. No.: 17/714,501

(22) Filed: Apr. 6, 2022

(30) Foreign Application Priority Data
Apr. 6, 2021 (DE) 10 2021 001 757.9
Jul. 20, 2021 (DE) 10 2021 118 787.7

(51) Int. Cl. E21C 31/02; E01C 23/088; E21C 25/10; H02K 7/075; H02K 7/10; H02K 7/18

(52) U.S. Cl. CPC E21C 31/02; E01C 23/088; E21C 25/10; H02K 7/075; H02K 7/1004; H02K 7/1815

(57) ABSTRACT

The present invention relates to a self-propelled ground milling machine, in particular, a road cold milling machine, stabilizer or recycler, comprising a milling device for milling the ground at a milling depth, a machine frame supported by front and rear travel units, a primary drive unit arranged on the machine frame, in particular, an internal combustion engine, an on-board electrical system, and a generator driven by the primary drive unit, which feeds electrical energy generated by it into the on-board electrical system.

### CROSS-REFERENCE TO RELATED APPLICATIONS

The present application claims priority under 35 U.S.C. § 119 of German Patent Application No. 10 2021 001 757.9, filed Apr. 6, 2021 and German Patent Application No. 10 2021 118 787.7, filed Jul. 20, 2021, the disclosures of which are hereby incorporated herein by reference in their entireties.

### FIELD OF THE INVENTION

The present invention relates to a self-propelled ground milling machine, in particular, a road cold milling machine, a stabilizer or a recycler, a method for operating a ground milling machine and a method for retrofitting a ground milling machine.

### BACKGROUND OF THE INVENTION

Generic ground milling machines, in particular, road cold milling machines, stabilizers or recyclers, are known, for example, from DE102014008749A1, DE102006062129A1, DE102005044211A1, EP185589981 and DE102014019168A1. Such ground milling machines are often used in road and pathway construction and for subsoil stabilization. Its working device is typically a milling device with, for example, a hollow-cylindrical milling drum, which is equipped with a plurality of milling tools on its outer circumferential surface. The milling drum is arranged inside a milling drum box which is open toward the ground. During working operation of the ground milling machine, the milling drum is set in rotation, usually about a horizontal rotation axis running transversely to the forward direction of the ground milling machine, and is lowered into the ground until a desired milling depth is reached. The ground milling machine then moves in the forward or working direction while continuing to mill ground material at said milling depth. This breaks up and crushes the ground to be processed, for example an asphalt surface of a road to be processed. The milled material produced in this process is conveyed, for example, via a discharge conveyor either in or against the working direction of the ground milling machine onto a transport vehicle and transported away by the latter.

In terms of its basic structure, the ground milling machine usually comprises a machine frame, which constitutes the essential support structure of the ground milling machine. Furthermore, one or more front and rear travel units are provided, which may be connected to the machine frame via lifting devices, in particular lifting columns. All travel units may be connected to the machine frame via lifting devices. An operator platform, which is usually arranged above the milling device, is provided for operating the ground milling machine.

Such a self-propelled ground milling machine is driven, in particular, by a primary drive unit, in particular a diesel combustion engine. In addition to a drive train for the milling drum, said combustion engine often drives numerous other consumers, such as one or more hydraulic pumps for supplying hydraulic actuators, such as, in particular, travel motors, actuators for, for example, lateral shields, a stripping plate, a hold-down device, a drive motor for a conveyor belt, a steering actuator, actuators for positioning a transport conveyor belt, lifting devices connecting the machine frame to travel units, etc. Moreover, the ground milling machine may comprise various electrical consumers. These may be, in particular, electronic control units, sensors, lighting elements, display devices, assistance systems, etc. The demand of a ground milling machine for electrical energy is highly dependent on the individual equipment of the particular machine. In order to be prepared for all eventualities in this respect, ground milling machines are therefore usually equipped with a generator that is far too large for most applications in terms of the electrical energy it can generate, or its power. This is not only disadvantageous in that large generators are typically more expensive. Such oversized generators also reduce the efficiency of the ground milling machine. Alternatively, it is also possible that a comparatively low-power generator provided ex works is dismounted and replaced by a more powerful generator when upgrading the ground milling machine. This approach requires a considerable amount of installation work.

Against this background, one aspect of the present invention is to provide a ground milling machine that covers, in a cost-effective manner, a wide range of demands for electrical energy generated via a generator.

### SUMMARY OF THE INVENTION

The present invention relates to a self-propelled ground milling machine, in particular a road cold milling machine, stabilizer or recycler, comprising a milling device for milling the ground at a milling depth, a machine frame supported by front and rear travel units, a primary drive unit arranged on the machine frame, in particular an internal combustion engine, an on-board electrical system, and a generator driven by the primary drive unit, which feeds electrical energy generated by it into the on-board electrical system. The ground milling machine may comprise, in addition to said one generator, a further generator driven by or connected to the primary drive unit. The primary drive unit thus drives the two generators simultaneously. This means that in the event of an increased demand of the current setup of the ground milling machine for electrical energy, two generators generating electrical energy in parallel can be used simultaneously, in particular, for common feeding into the common on-board electrical system. If, on the other hand, the current setup of the ground milling machine requires comparatively little electrical energy, the second generator is dispensable. It may then, for example, not even be installed in the ground milling machine. By relying on two relatively low-power generators at the same time, in addition to system redundancy, a wide range of potentially deliverable electrical energy is made available to the on-board electrical system of the ground milling machine in a comparatively inexpensive manner. Moreover, the use of two “small” generators brings the further advantage that the on-board voltage can be kept comparatively low, for example at preferably 24V. This means that regular service personnel can also maintain and repair the on-board electrical system, whereas specially trained maintenance personnel must be deployed for on-board voltages of 230V and more, for example.

It is advantageous, for example with regard to a supply with spare parts, if the two generators are identical in construction. Ideally, the two generators are three-phase generators and/or both are connected to the same on-board electrical system.

A connection of the two generators is such that they generate essentially the same electrical power given a same drive power applied to the respective generator. This considerably facilitates synchronization of the two generators for feeding into the on-board electrical system. Additionally or alternatively, both generators are preferably driven by the primary drive unit with a same gear ratio.

Additionally or alternatively, both generators may be arranged on the machine such that practically the same environment is provided with regard to their ambient operating conditions, in particular, for example, with regard to their respective ambient temperature. For example, both generators may be arranged in the same internal compartment of the ground milling machine, for example in the engine compartment, ideally on a same side of the primary drive unit. Independently of this, both generators may be additionally or alternatively arranged close to each other, i.e., in particular, at a maximum distance of 30 cm from each other.

As a further addition or alternative, the distances of the two generators from the battery of the ground milling machine may be equal with regard to the cable length and/or the cable cross-section, at least within a maximum range of +/−10%, within a maximum range of +/−5%. In this manner, identical resistance ratios can be established on both generators, which greatly facilitates simultaneous operation of both generators for feeding into the common on-board electrical system.

The two generators are driven simultaneously by the primary drive unit, such as via a traction drive driven by a pulley seated on the rotation axis of a crankshaft of the primary drive unit according to one embodiment. It is advantageous if the respective gear ratio from the primary drive unit to the two generators is identical. Both generators may be driven by a common traction means. However, it is also possible for the two generators to be driven by separate traction means, with both traction means being driven by a respective pulley arranged directly on the crankshaft of the primary drive unit according to one embodiment.

One or both generators may have a speed-variable gear ratio relative to the output shaft of the primary drive unit. It is also possible to provide at least one coupling device between the primary drive unit and at least one or both generators, or a respective coupling device for each of the two generators. With the aid of the coupling device, the drive connection between the primary drive unit and the respective at least one generator can be selectively interrupted or established.

There are also advantageous arrangement options with regard to their arrangement relative to each other. The two generators may be arranged offset one behind the other in the axial direction of the rotation axis of the crankshaft, enabling a relatively compact overall arrangement together with the primary drive unit. From a constructional point of view, it is advantageous for the connection of a drive gear cooperating with the primary drive unit if the input shafts of the two generators project away from the main output side of the primary drive unit in a direction parallel to the rotation axis of the crankshaft. The main output side of the primary drive unit in this case refers, in particular, to the side on which the majority of the drive power generated by the primary drive unit is tapped during milling operation of the ground milling machine. At least one of the two generators is driven by a single-stage traction drive. Additionally or alternatively, one of the two generators is driven by a two-stage traction drive. In a two-stage traction drive, two traction means are arranged in series. A single-stage traction drive comprises only one traction means. The gear ratio from the output axle of the primary drive unit to the input shafts of the two generators is ideally identical. The two generators may both be arranged on a same side of the primary drive unit.

Another part of a ground milling machine according to one embodiment of the present invention is a control unit, in particular, comprising a charge controller, which controls the feed of electrical energy into the common on-board electrical system by the two generators. Such a control unit may be configured as an electronic module, for example. The charge controller, which may be integrated into the control system, is configured in one embodiment to monitor the speed of both generators. It may also be configured to synchronize the charge portions of both generators. Additionally or alternatively, the control system may query the integration of the second generator into the on-board electrical system before the machine and/or the on-board electrical system is put into operation. This may be a minimum requirement for operation in a specified voltage range, for example 24V.

It is also possible for one or both of the generators to be driven hydraulically. For this purpose, the primary drive unit may initially drive one or more hydraulic pumps that supply hydraulic drive energy to hydraulic motors driving at least one or both of the generators.

Both generators may be stationary with respect to each other, in particular, in a jointly vibrating subregion of the machine, for example on a common support structure.

From a constructional point of view, it may also be advantageous to have a mounting frame flanged to an engine mount, on which only one of the two generators is arranged. This is particularly suitable for retrofit purposes, as it is further preferred if the further generator can be retrofitted. Ideally, the mounting frame is rigidly flanged to the engine mount without damping.

It is known that generic ground milling machines may have a so-called auxiliary drive. The auxiliary drive may be operated independently of the primary drive unit or, depending on the embodiment, may even be operated only when the primary drive unit is switched off. This auxiliary drive may, for example, provide the drive energy required for emergency or maintenance operation. For this purpose, a generator may also be driven by this auxiliary drive for these purposes in order to generate electrical energy in auxiliary operation. However, this generator is then not one of the two generators driven by the primary drive unit, but a third generator which is specially adapted to be driven by the auxiliary drive, for example a small, comparatively low-power internal combustion engine.

Another aspect of the present invention lies a method for operating a ground milling machine, wherein electrical energy required for operating the ground milling machine is generated by means of two generators driven simultaneously by the primary drive unit and is fed into a common on-board electrical system. With regard to specific details on the configuration of the two generators, reference is made to the above discussions.

The simultaneous feeding of electrical energy into the common on-board electrical system may be synchronized with each other such that the sum of the charge components fed into the on-board electrical system via the two generators per unit of time is at least essentially constant. An integrated charge controller may be provided for this purpose, for example also as part of the control unit.

Finally, a further aspect of the present invention relates to a method for retrofitting a ground milling machine, in particular, a road cold milling machine, a stabilizer or a recycler, comprising a milling device for milling the ground at a milling depth, a machine frame supported by front and rear travel units, a primary drive unit arranged on the machine frame, in particular, an internal combustion engine, an on-board electrical system, and a generator driven by the primary drive unit, which feeds electrical energy generated by it into the on-board electrical system, with a second generator to be driven by the primary drive unit. Essentially, said retrofitting may comprise at least one of the following steps: doubling the cross-sectional area of lines in the charging circuit, either by installing one or more additional lines or by replacing previous lines by lines having essentially double the cross-sectional area in the charging circuit of the battery; arranging the second generator in direct adjacency to the first generator; arranging the second generator on a mounting structure that is rigid with respect to the first generator.

### BRIEF DESCRIPTION OF THE DRAWINGS

The present invention will be described in more detail below by reference to the embodiment examples shown in the figures; In the schematic figures:

FIG. 1 is a side view of a ground milling machine of the center rotor type;

FIG. 2 is a schematic top view of individual components of a drive system of the ground milling machine of FIG. 1;

FIG. 3 is a top view of a power take-off side of the primary drive unit;

FIG. 4 is an oblique perspective top view of the power take-off side of the primary drive unit of FIG. 3; and

FIG. 5 is an oblique perspective top view of the detail shown in FIG. 4.

Structurally or functionally like components are designated by like reference numerals in the figures, although not every recurring component is designated separately throughout the figures.

### DETAILED DESCRIPTION OF THE INVENTION

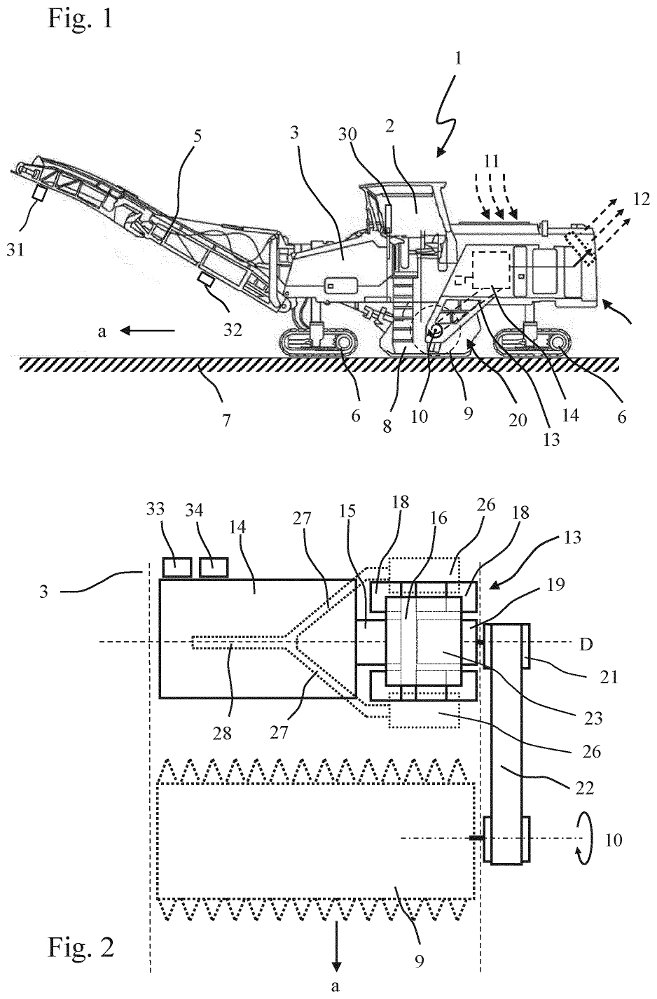

FIG. 1 shows a ground milling machine 1 of the road cold milling machine type (center rotor type) with an operator platform 2 and a machine frame or chassis 3. The ground milling machine 1 is self-propelled and has travel units 6 for this purpose, for example crawler tracks or wheels. During milling operation, the ground milling machine machine 1 moves in the working direction a over the ground 7 to be processed. While doing so, the ground milling machine 1 mills the ground 7 at a milling depth with a milling drum 9 of a milling device 20 mounted for rotation about the rotation axis 10 in a milling drum box 8. The milled material removed may, for example, be transferred in working direction a via a discharge device 5, for example a conveyor belt, to a transport vehicle not shown and transported away by it. Moreover, the ground milling 1 may comprise a drive train 13. In order to cool components of this drive train 13, a cooling air supply is provided, among other things, as part of a cooling system, which is configured such that supply air 11 is drawn in at the top side of the ground milling machine 1 in a region of the ground milling machine 1 that is located behind the operator platform 2 in the working direction a. Via exhaust air openings arranged at the rear of the ground milling machine 1, the heated exhaust air 12 is blown out to the rear in the opposite direction to the working direction a and diagonally upward (for example through corresponding guide vanes in the outlet region).

An exemplary drive train 13 of the ground milling machine 1, in particular, for a road cold milling machine, is shown schematically in FIG. 2. It may comprise an internal combustion engine 14, for example a diesel engine, as the primary drive unit, the crankshaft of which rotates about the rotation axis D. The crankshaft may be connected to a clutch 15. A pump transfer gear 16 may adjoin the clutch in the axial direction of the rotation axis. Several units 18, such as, in particular, one or more hydraulic pumps, also in tandem arrangement, of a hydraulic system, may be flanged to distributor shafts of the pump transfer gear 16 and driven by it. The hydraulic system may, for example, be configured such that hydraulic pumps are used to drive hydraulic motors, which are used, for example, to drive the travel units 6 or to drive the conveyor 5 of the ground milling machine 1. Other actuators, such as linear actuators, may also be supplied with hydraulic drive energy via this system, for example, for shield control of the milling device 20, for adjustment of the conveyor device 5, etc. All required hydraulic pumps of the ground milling machine 1 may be coupled to the pump transfer gear 16 and supplied with energy by it. A shifting clutch 19 may adjoin the pump transfer gear 16 in the axial direction of the rotation axis, which in turn is in drive connection with a drive roller 21 of a traction drive 22 driving the milling drum 9. The rotation axis D can be parallel to the rotation axis 10 of the milling drum and thus horizontal and perpendicular to the forward direction a.

Part of the hydraulic system is also a hydraulic tank 23, which, as shown in FIG. 2, is arranged above the pump transfer gear 16 and in the direction of the rotation axis between the internal combustion engine and the traction drive 22. The arrangement may further include two air filters 26 arranged upstream and downstream of the hydraulic tank 23, as viewed in the forward direction a at the level of the hydraulic tank 23. Toward the internal combustion engine, supply lines 27 extend from each of the air filters 26 and, as shown in the top view in FIG. 2, converge at the level of the internal combustion engine to form a common air supply line 28.

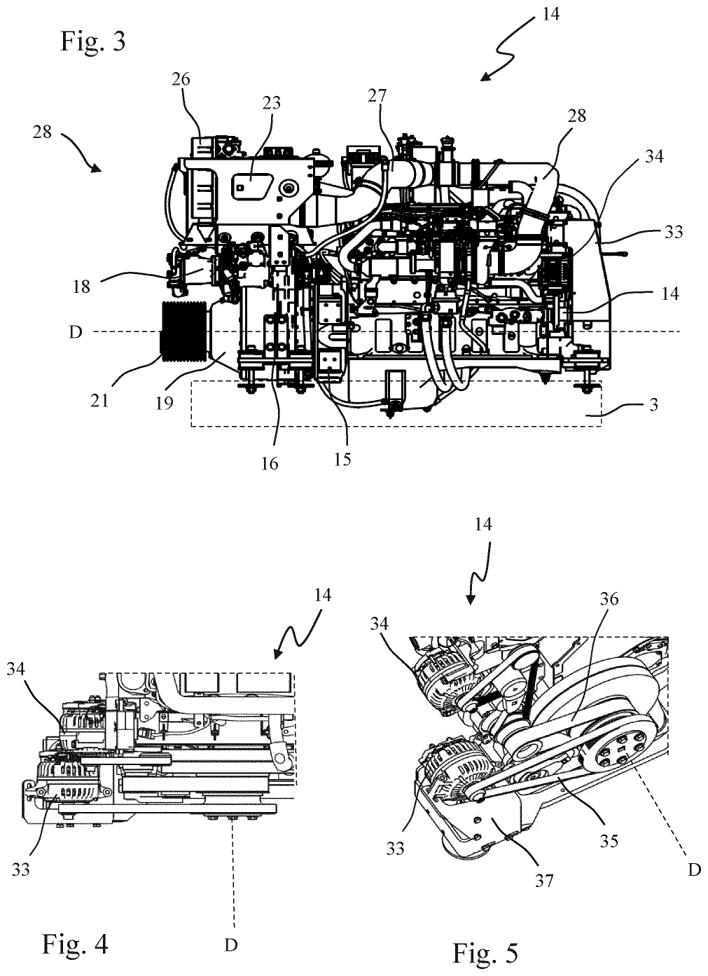

The ground milling machine may comprise a plurality of electrical consumers, such as display devices 30, cameras 31, external lighting devices 32, etc. To supply these electrical consumers, the ground milling machine may comprise an on-board electrical system not specified in detail in the figures. One or more batteries/accumulators may be part of this on-board electrical system. Electrical energy can be generated simultaneously on the ground milling machine 1 with the aid of generators 33 and 34. Their possible arrangement is shown by way of example in FIGS. 3 to 5. Not shown in the figures is a control unit that communicates with the generators 33 and 34 and controls their feed to the common on-board electrical system of the ground milling machine 1.

The two electrical generators 33 and 34 may be of identical design. They are connected in the region of the power take-off side of the same primary drive unit 14 opposite the main output side connected to coupling 15. The two generators 33 and 34 are driven by means of traction drives, which are specifically located at least partially on the crankshaft rotation axis D. The traction drive 35 toward the generator 33 is single-stage. The traction drive 36, on the other hand, includes two belts arranged in series. This makes it possible to drive both generators 33 and 34 simultaneously from the primary drive unit 14. The electrical energy generated by the two generators 33 and 34 is fed into the common on-board electrical system. Both generators 33 and 34 thus supply electrical energy to a common on-board electrical system rather than to separate on-board electrical systems.

The generator 33 is arranged on a mounting frame 37, which is flanged to an engine mount via threaded connections. Thus, the mounting frame 37 can be easily dismounted or, conversely, easily retrofitted together with the generator 33 if the currently selected setup of the ground milling machine 1 has an increased overall demand for electrical energy.

The ground milling machine may also have an auxiliary drive via which drive energy can be generated independently and with the primary drive unit switched off. This auxiliary drive, for example an internal combustion engine with significantly less power than the primary drive unit, may drive a generator (not shown in the figures). It is essential, however, that this generator is not drivable by the primary drive unit and, conversely, neither of the generators 33 and 34 is drivable via said auxiliary drive.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A self-propelled ground milling machine comprising:
a milling device for milling a ground at a milling depth;
a machine frame supported by front and rear travel units;
a primary drive unit arranged on the machine frame;
an on-board electrical system; and
a first generator driven by the primary drive unit, which feeds electrical energy generated by it into the on-board electrical system,
wherein an additional second generator driven by the primary drive unit is provided.

2. The self-propelled ground milling machine according to claim 1,
wherein the two generators include at least one of the following features:
the two generators are of identical design;
the two generators are three-phase generators;
the two generators are both connected to the same on-board electrical system;
the two generators are connected such that the two generators generate essentially the same electrical power given a same power applied to the respective generator; and
the two generators are driven simultaneously by the primary drive unit.

3. The self-propelled ground milling machine according to claim 1,
wherein the two generators include at least one of the following features:
the two generators are arranged offset one behind the other in an axial direction of a rotation axis of a crankshaft of the primary drive unit; and
the two generators have input shafts that project from a main output side of the primary drive unit in a direction parallel to the rotation axis of the crankshaft;
one of the two generators is driven by a single-stage traction drive;
one of the two generators is driven by a two-stage traction drive;
a gear ratio from an output axle of the primary drive unit to the input shafts of the two generators is identical; and
the two generators are both arranged on a same side of the primary drive unit.

4. The self-propelled ground milling machine according to claim 1,
wherein a control unit is provided which controls the feed of electrical energy by the two generators into the common on-board electrical system.

5. The self-propelled ground milling machine according to claim 1,
wherein a mounting frame flanged to an engine mount is provided, on which only one of the two generators is arranged.

6. The self-propelled ground milling machine according to claim 1,
wherein the additional second generator can be retrofitted.

7. A method for operating a ground milling machine according to claim 1,
wherein electrical energy required for operating the ground milling machine is generated by the two generators driven simultaneously by the primary drive unit and is fed into a common on-board electrical system.

8. The method according to claim 7, further comprising:
simultaneously feeding electrical energy into the common on-board electrical system in a manner synchronized with each other such that a sum of charge components fed into the on-board electrical system via the two generators per unit of time is at least essentially constant.

9. A method for retrofitting a ground milling machine according to claim 1, further comprising:
doubling a cross-sectional area of lines in a charging circuit, either by installing one or more additional lines or by replacing previous lines by lines having essentially double the cross-sectional area in the charging circuit; and/or
arranging the additional second generator in direct adjacency to the first generator; and/or
arranging the additional second generator on a mounting structure that is rigid with respect to the first generator.

10. The self-propelled ground milling machine according to claim 1,
wherein the self-propelled ground milling machine comprises a road milling machine, a stabilizer or a recycler.

11. The self-propelled ground milling machine according to claim 1,
wherein the primary drive unit comprises an internal combustion engine.

12. The self-propelled ground milling machine according to claim 2,
wherein the two generators are driven simultaneously by the primary drive via a traction drive driven by a pulley seated on a rotation axis of a crankshaft of the primary drive unit.

13. The self-propelled ground milling machine according to claim 5,
wherein the control unit comprises a charge controller.
